(19) United States
(12) Patent Application Publication
(10) Pub. No.: US 2004/0248492 A1
(43) Pub. Date: Dec. 9, 2004

(54) Nonwoven fabric printing medium and method of production

(75) Inventor: John Frank Baker JR., Nashville, TN (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Reemay, Inc.

(21) Appl. No.: 10/832,033

(22) Filed: Apr. 26, 2004

Related U.S. Application Data
(60) Provisional application No. 60/476,459, filed on Jun. 6, 2003.

(51) Int. Cl. B32B 5/26; D04H 3/00; D04H 3/16; D06N 7/04

(52) U.S. Cl. 442/381; 428/141; 442/334; 442/337; 442/382; 442/401

(57) ABSTRACT

A nonwoven fabric printing medium comprises a first nonwoven fabric layer formed of thermoplastic polymer continuous filaments and at least one additional nonwoven fabric layer bonded to the first nonwoven fabric layer to form an integral unitary composite sheet material. The first nonwoven fabric layer has an outer surface adapted to receive printing ink, and the nonwoven fabric printing medium has a porosity of no more than 75 CFM pursuant to ASTM D-737-80, and in a preferred embodiment no more than 25 CFM. The first nonwoven fabric layer includes a thermoplastic polymer binder bonding together the thermoplastic polymer continuous filaments and also bonding the first nonwoven fabric layer to the one or more additional nonwoven fabric layers.

### CROSS-REFERENCE TO RELATED APPLICATION

This application claims the benefit of U.S. Provisional Application No. 60/476,459, filed Jun. 6, 2003.

1. Field of the Invention

The present invention is directed to nonwoven fabrics suitable for use as a medium for printing. The present invention is more specifically directed to nonwoven fabrics suitable for printing by ink-jet printers or by other conventional printing processes.

2. Background of the Invention

Although paper is perhaps the most widely used medium for printing, there are many applications where paper cannot be used because of its lack of strength, waterproofness, weather resistance, archival quality or other physical property. For example, outdoor signs or banners must be capable of resisting weather elements such as wind, rain, freezing and exposure to ultraviolet light. For these applications, various alternative printing media have been developed, such a vinyl coated woven fabrics, films, and nonwoven fabrics. For example, DuPont markets its Tyvek® brand nonwoven fabric for graphics and printing applications. Tyvek is a flash spun nonwoven fabric made from very fine high density polyethylene fibers bonded together by heat and pressure. Because polyethylene has a relatively low melting point, Tyvek is not recommended for printing processes that involve temperatures in excess of about 175° F.

The use of nonwoven fabrics as a printing medium has been proposed in various prior patent documents, such as for example, U.S. Pat. Nos. 5,240,767 and 5,853,861. However, little attention is given to the structural and physical properties of the nonwoven fabric required to make the fabric a commercially acceptable printing substrate. One of the problems inherent with the manufacture of nonwoven fabrics by conventional manufacturing methods is that the fiber deposition can be uneven or variable, producing thick and thin spots or other variations in basis weight that render the material unappealing or unsuitable for use as a printing medium. As a result, very few nonwoven fabrics have found commercial acceptance as a printing medium.

The present invention addresses the problem of providing a nonwoven fabric with a sufficiently uniform thickness and basis weight and sufficient structural properties to be suitable for use in various commercial printing operations such as, for example, ink-jet printing and laser printing, as well as the more traditional printing technologies of flexography, lithography, letterpress printing, gravure and offset.

### BRIEF SUMMARY OF THE INVENTION

The nonwoven fabric printing medium of the present invention comprises a first nonwoven fabric layer formed of thermoplastic polymer continuous filaments and at least one additional nonwoven fabric layer bonded to the first nonwoven fabric layer to form an integral unitary composite sheet material. The first nonwoven fabric layer has a calendered outer surface adapted to receive printing ink, and the nonwoven fabric printing medium has a porosity of no more than 75 CFM pursuant to ASTM D-737-80, and in a preferred embodiment no more than 25 CFM. The first nonwoven fabric layer includes a thermoplastic polymer binder bonding together the thermoplastic polymer continuous filaments and also bonding the first nonwoven fabric layer to the one or more additional nonwoven fabric layers. In one advantageous embodiment, the continuous filaments of the first layer have a trilobal cross-section and are formed from polyester. In a specific embodiment, the first nonwoven fabric layer comprises a spunbond nonwoven formed from continuous polyester homopolymer matrix filaments of a trilobal cross-section, and a fibrous binder of a lower-melting polyester copolymer which bonds the continuous matrix filaments, and at least one additional nonwoven fabric layer of the composite comprises a second spunbond nonwoven fabric bonded to said first fabric, this second spunbond fabric being formed from continuous polyester homopolymer matrix filaments of a trilobal cross-section, and a fibrous binder of a lower-melting polyester copolymer which bonds the continuous matrix filaments.

### BRIEF DESCRIPTION OF THE DRAWINGS

The foregoing and other objects, features, and advantages of the present invention will be made apparent from the following detailed description of the invention and from the drawings, in which:

FIG. 1 is a schematic illustration of an enlarged cross-sectional view of an exemplary printing medium formed in accordance with the invention; and

FIG. 2 is a schematic illustration of an exemplary process for manufacturing the printing media of the present invention.

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

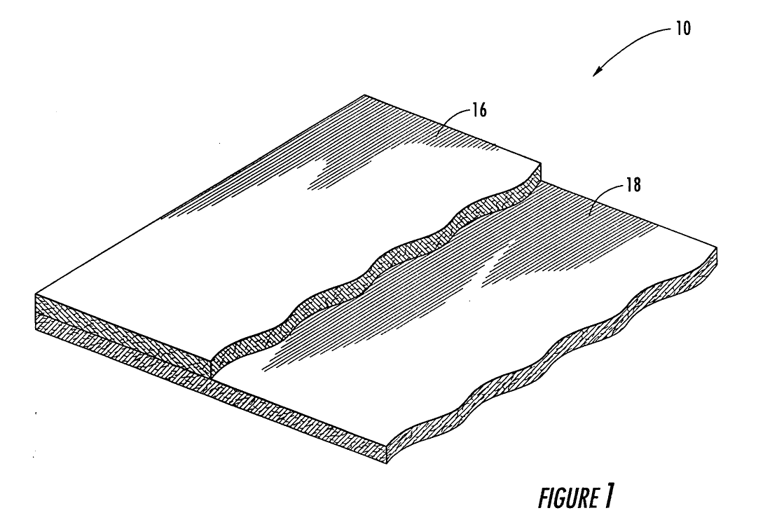

An exemplary printing medium in accordance with the present invention is shown in FIG. 1. The medium 10 comprises a composite nonwoven fabric including at least two nonwoven fabric layers that have been bonded together in opposing face-to-face relationship. Although the composite medium is referred to as including “layers,” this term is merely used to facilitate discussion concerning the differing compositions and/or constructions which may be present in various regions within the printing medium. The medium, although referred to as being formed from such “layers,” nevertheless provides a unitary structure exhibiting cohesive properties throughout its thickness.

The first layer 16 of nonwoven fabric is preferably a spunbond nonwoven fabric formed of a plurality of continuous thermoplastic polymer filaments. More particularly, the spunbond fabric typically includes from about 80 to 100% weight percent continuous thermoplastic polymer filaments. As used herein, the terms “filament” and “continuous filament” are used in a generic sense to refer to fibrous materials of indefinite or extreme length, such as a length of several feet or greater. As is well-known, spunbond nonwoven fabrics are made by extruding a thermoplastic fiber-forming polymer through a spinneret having a large number of orifices to form filaments, drawing or attenuating the extruded polymer filaments mechanically or with a stream of high velocity air, depositing the filaments randomly on a collecting surface to form a web, and bonding the filaments to form a strong, coherent fabric. The titer of the filaments within the first layer 16, expressed in denier per filament (“dpf”), typically ranges from about 1 to 10 dpf, such as from about 4 to 6 dpf. In certain preferred embodiments, the spunbond filaments within the first layer 16 have a fineness of about 4 dpf, particularly 4 dpf fibers with a trilobal cross sectional shape. In alternative embodiments, the spunbond filaments may have a mixture of deniers.

The continuous filaments within the spunbond first layer 16 may be formed from any fiber-forming thermoplastic polymer providing acceptable mechanical properties and chemical resistance. For example, continuous polymeric filaments may be formed from polyester homopolymers and/or copolymers, or from polyamide homopolymers and/or copolymers or mixtures thereof. An exemplary polyester is polyethylene terephthalate. Exemplary polyamides include nylon 6 and nylon 6,6. In advantageous specific embodiments of the invention, the continuous filaments within the first layer 16 are formed from polyethylene terephthalate. The filaments may additionally include conventional additives such as stabilizers, UV inhibitors, pigments, whiteners, delusterants, optical brighteners and the like.

The first layer 16 may be formed from spunbond continuous filaments of various cross sections, including trilobal, quadlobal, pentalobal, circular, elliptical and dumbbell-shaped. Either a single cross-section or a mixture of filaments of differing cross section may be included within the first layer 16. In preferred embodiments of the invention, the first layer 16 is formed from spunbond filaments having a trilobal cross section. The trilobal cross-section of the filaments enhances print definition while providing a base of material that appears to absorb light rather than reflecting it to cause a shiny appearance. The trilobal filament also enhances the capture of inks and ink receptive coatings.

Applicant has found that spunbond layers possessing fairly uniform structures can provide an unexpectedly smooth printing surface for a synthetic printing medium, especially when calendered using heated calender rolls. The fabric can be provided with a completely smooth surface using smooth calender rolls, or with a uniform textured surface simulating canvas or other fabric using appropriately patterned calender rolls. Exemplary apparent densities for the first layer 16 prior to calendering generally range from about 0.100 g/cc to 0.250 g/cc, such as apparent densities ranging from about 0.100 g/cc to 0.150 g/cc.

To provide adequate intralaminar strength within the first layer 16, the continuous filaments within the spunbond first layer 16 are bonded to each other at points of contact. Although the continuous filaments within the spunbond first layer 16 are bonded, the nonwoven structure remains flexible and sufficiently porous to provide beneficial ink transport properties. The bonding within the first layer 16 can be accomplished thermally or by ultrasonic energy, such as by the melting of thermoplastic binder filaments, thermoplastic resin bonding, etc. The bonding can be throughout the nonwoven fabric structure (known as “area bonding”) which is preferred when a uniformly smooth outer printing surface is desired, or the bonding can be in discrete areas (typically referred to as “point bonding”) which can provide a beneficial textured appearance to the printing surface. In advantageous specific embodiments, the first layer 16 is bonded using a fibrous binder. The fibrous binder may be included within the first layer 16 during the manufacturing process as continuous binder filaments in an amount effective to induce an adequate level of bonding. The binder is typically present in the first layer 16 in an amount ranging from about 2 to 20 weight percent, such as an amount of about 10 weight percent. In alternative aspects of the invention, the spunbond filaments within the first layer 16 may be multiconstituent fibers that include a thermoplastic binder polymer as a component. For example, in such alternative embodiments the spunbond filaments may have a sheath/core configuration in which the sheath is formed from a binder polymer.

The binder filaments used in the first layer 16 are generally formed from a polymer exhibiting a melting or softening temperature at least about 10° C. lower than the continuous filaments. The binder filaments may all be formed from the same polymer or may include a mixture of higher and lower melting binder filaments. For example, the binder filaments may include a mixture of filaments, a first portion of which have a lower melting temperature, such as about 225° F., and a second portion of which have a higher melting temperature, such as about 375° F. Exemplary binder filaments may be formed from one or more lower melting polymers or copolymers, such as polyester copolymers. In one advantageous embodiment of the invention, the spunbond layer is produced by extruding polyester homopolymer matrix filaments (polyethylene terephthalate) interspersed with binder filaments formed from a lower melting polyester copolymer, such as polyethylene isophthalate. It will be understood that during the manufacturing process, when the higher melting continuous matrix filaments of the first layer 16 are bonded to form a coherent layer, the lower-melting binder filaments will typically soften and flow to bond the matrix filaments at cross-over points, and thereafter may not necessarily be readily identifiable as continuous binder filaments

To provide enhanced uniformity of basis weight and thickness, the first layer 16 is laminated to at least one additional nonwoven layer of either the same or differing construction. Laminating two or more layers together reduces the effect of any non-uniformities in basis weight in the individual layers. In the embodiment shown in FIG. 1, a second nonwoven layer 17 is bonded to the first layer 16, with the second layer forming the rear surface of the composite medium 10. In the embodiment illustrated in FIG. 1, both the first layer 16 and the second layer 17 are spunbond nonwoven fabrics formed of continuous filaments. In other embodiments, the composite support 10 may include three, four, or more spunbond nonwoven layers laminated together. In still other embodiments, one or more intermediate nonwoven layers of another nonwoven construction, such as an air-laid nonwoven, a carded nonwoven, spunlace nonwoven, or a wet-laid nonwoven can be incorporated in the composite. For embodiments including at least two spunbond layers, the fibers and materials comprising the respective spunbond layers may be the same or may differ. For example, the spunbond layers may differ in composition, denier, basis weight or fiber cross-section.

In the embodiment shown, the second layer 18 is also a spunbond nonwoven fabric formed from a plurality substantially continuous thermoplastic polyester filaments including higher melting matrix filaments and a lower melting binder. The binder filaments provided in the second layer 18 are generally formed from a polymer exhibiting a melting or softening temperature at least about 10° C. lower than the matrix filaments. The binder filaments may all be formed from the same polymer or may include a mixture of higher and lower melting binder filament compositions. For example, the binder filaments may include a mixture of filaments, a first portion of which have a lower melting temperature, such as about 225° F., and a second portion of which have a higher melting temperature, such as about 375° F. Exemplary binder filaments may be formed from one or more low melting polyolefin polymers or copolymers, one or more low melting polyester polymers or copolymers or mixtures thereof. In one advantageous embodiment of the invention, the binder filaments are formed from a low melting polyester copolymer, particularly a polyethylene isophthalate copolymer, and the matrix filaments are formed of polyethylene terephthalate homopolymer.

The binder filaments used in producing the second layer 18 may have any cross-section known in the art. In preferred embodiments, the binder filaments of the second layer 18 have a circular cross-section as initially formed. The binder filaments may have a denier or mixture of deniers consistent with that known in the art for binding nonwoven fabrics.

One important property of the printing medium 10 is its basis weight. For desirable operation in automated feed printers, the printing medium should have a basis weight of at least about 3 ounces per square yard (osy) (at least about 102 grams per square meter). The printing medium preferably has a basis weight of 3 to 12 ounces per square yard (102-407 grams per square meter). Particularly suitable are fabrics with a basis weight of from 3.0 to 4.0 ounces per square yard (102 to 136 grams per square meter). Higher weights can be used successfully in applications where a stiffer sheet material is desired.

The composite printing medium 10 is quite strong and tear resistant. The printing medium is characterized by having a grab tensile strength in both the machine direction (MD) and the cross direction (XD) of at least 100 pounds, more desirably at least 120 pounds, and for heavier basis weights in excess of 200 pounds. Representative tensile properties of two different weights of uncoated printing medium in accordance with the present invention are given in Table 1.

TABLE 1

| | | MD Grab Tensile | XD Grab Tensile |
|---|---|---|---|
| Sample | Basis Weight ((osy) | (lbs.) | (lbs.) |
| A | 4.6 | 154 | 140 |
| B | 8.2 | 242 | 240 |

Grab tensile strength is the force required to elongate and break a pre-cut sample on a tensile tester, such as the Instron® tester. Samples are tested from the machine direction (MD) and cross direction (XD) in accordance with standard test method ASTM 4632-96. Basis weight is measured according to ASTM D2776-96.

Another important property affecting the suitability of the substrate is its ink transport properties. It is desirable that the ink will penetrate somewhat into the medium, but not so much that the ink will migrate into the interior of the web to result in dull colors. Thus, some degree of porosity is needed in the medium. The porosity of the medium can be measured by standard air permeability measurements that ascertain the flow of air through a given area of web at a given pressure. Standard test method ASTM D-737-80 can be used for this purpose. Preferably, the medium has an air porosity of no higher than 75 CFM as measured by ASTM D-737-80, and more desirably no more than 50 CFM. The preferred air permeability is between 5 and 25 CFM.

The composite printing medium 10 of the present invention has especially advantageous archival properties, since it can be formed entirely from relatively inert polymers and without the presence of wood pulp or other reactive or degradable materials. The printing medium is lightweight and flexible and in contrast to paper, it resists creasing even after folding. Furthermore, it can withstand repeated folding and unfolding without creasing, tearing or loss of tensile strength. Additionally, it can be made entirely from inherently hydrophobic synthetic polymers, so that the printing medium is not sensitive to exposure to water or to high humidity environments. The continuous filament bonded structure of the printing medium assures a clean, non-linting material that can be used in applications, such as clean rooms, where airborne particulates are to be avoided. The printing medium resists curl and wrinkling, and forms clean cut edges without raveling or fraying. It can be glued, sewn, hole-punched, stapled or pinned without losing strength.

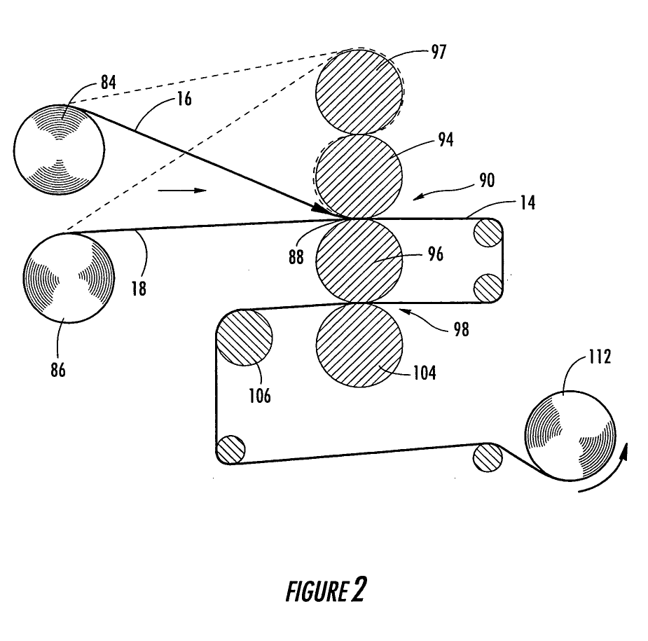

FIG. 2 illustrates a suitable process and apparatus for producing the composite printing medium 10 of the present invention. Two spunbond nonwoven webs 16, 18 are unwound from respective rolls 84 and 86 and are brought together into a superposed opposing face-to-face relationship. The superposed layers 88 are subsequently conveyed longitudinally through a first nip 90. Within the first nip 90, the lower-melting copolymer binder present in the first spunbond fabric layer 16 and the copolymer binder present in the second layer 18 will be heated to the point that the binder begins to soften and fuse to adhere the layers together without the necessity of any additional adhesive or binder. The first nip 90 is constructed in a conventional manner as known to the skilled artisan. In the embodiment illustrated in FIG. 2, the first nip 90 is defined by a pair of cooperating calender rolls 94 and 96, which are preferably smooth and advantageously formed from steel. The cooperating calender rolls 94 and 96 preferably provide a fixed gap nip. The fixed gap nip ensures that the superposed layers 88 will not exit the first nip 90 thinner than the targeted gap thickness, regardless of any excess pressure that may be applied. In the advantageous embodiment illustrated in FIG. 2, pressure is applied to the first nip 90 using a topmost roll 97.

Bonding conditions, including the temperature and pressure of the first nip 90, are known in the art for differing polymers. For composite printing media comprising polyethylene terephthalate nonwoven spunbond filaments and further including polyethylene isophthalate binder filaments and/or fibers, the first nip 90 is preferably heated to a temperature between about 120° C. and 230° C., preferably from about 200 to 225° C. The first nip 90 is typically run at pressures ranging from about 40 to 350 pounds per linear inch (pli), such as from about 80 to 200 pli.

In an alternative embodiment, shown by broken lines, the two superposed layers 88 can be partially wrapped around an additional roll, e.g. passing over the top roll 97 and then through the nip defined between rolls 97 and 94, which is heated to a temperature of about 200° C. prior to passing through the nip 90 between rolls 94, 96. Passing the superposed webs 88 over the additional heated roll 97 prior to the calender rolls 94, 96 preheats the superposed layers 88 before they enter the nip 90. Such preheating allows increased bonding speeds.

Returning now to FIG. 2, the superposed layers exiting the first nip 90 subsequently enters a second nip 98. The second nip 98 is formed by a top roll 96 and a bottom roll 104. The rolls 96 and 104 are preferably steel.

The pressure within the second nip 98 is typically higher than the pressure in the first nip 90, further compressing the superposed layers exiting the first nip 90. Consequently, the gap formed by the second nip 98 is narrower than the gap provided by the first nip 90. The pressure in the second nip 98 is typically about 120 to 1100 pli, such as from about 180 to 320 pli. The second nip 98 may further be heated, such as to a temperature ranging from about 120 to 230° C., preferably from about 200° C. to 225° C. Because of the presence of the thermoplastic copolymer binder in the layers, the two layers 16, 18 become bonded together to form an integral, unitary, coherent composite nonwoven without the requirement of additional adhesive compositions. The resultant bonded composite support 14 exiting the second nip 98 may be transported over a chill roll 106 and wound up by conventional means on a roll 112.

The composite printing medium 10 can be used in the uncoated, calendered state, or it can be provided with an ink-receptive coating on one or both surfaces. The coating can be applied before or after calendering or both. Suitable coatings include the kinds of coating compositions conventionally used in producing coated paper. Such coating compositions typically have an aqueous or other solvent-based binder and can include pigments and fillers such as silica, calcium carbonate, kaolin, cacined kaolin, clay, titanium oxide, aluminum silicate, magnesium silicate, magnesium carbonate, magnesium oxide, zinc oxides, tin oxides, zinc hydroxide, aluminum oxide, aluminum hydroxide, talc, barium sulfate and calcium silicate, boehmite, pseudo-boehmite, diatomaceous earth, styrene plastic pigments, urea resin plastic pigments and benzoguanamine plastic pigments. Exemplary binders include polyvinyl alcohol, styrene-butadiene polymers, acrylic polymers, styrene-acrylic polymers, and vinyl acetate and ethylene-vinyl acetate polymers. Commercially available examples of such binders include acrylic polymers such as RHOPLEX B-15 and RHOPLEX P-376, and vinyl acetate/acrylic polymers such as Polyco 2152 and Polyco 3250, all made by Rohm and Haas Company, and styrene/butadiene polymers such as CP 620 made by Dow Chemical Company. The coating composition can additionally include additives, such as flame retardants, optical brighteners, water resistance agents, antimicrobials, UV stabilizers and absorbers, and the like. The coating composition can be tailored for the particular printing technology intended to be used in the printing operation. Thus, for example, a printing medium intended for inkjet printing can be provided with a coating receptive to the solvent or aqueous based dyes or pigments used in the inkjet process, while a medium for laser printing would have a coating receptive to the toner used in laser printing. Suitable coating compositions of this type are commercially available from a variety of vendors and a coating formulation appropriate for a specific end-use printing application can be readily obtained.

When the printing medium is intended for high resolution images, such as photographs, the surface is desirably calendered with a smooth calender roll to achieve a surface roughness R_{z} of no more than 10 μm, and preferably no more than 5 μm. As is well known, the surface roughness parameter R_{z} represents the average of 5 Rₘₐₓ values, where Rₘₐₓ represents the largest peak to valley height in any of 5 sampling lengths. The surface roughness parameter R_{z} can be readily measured using a commercially available surface roughness testers, such as those available from Qualitest International Inc. or Edmund Optics for example.

The following examples are provided for purposes of further illustrating specific embodiments of the invention. It should be understood, however, that the invention is not limited to the specific details given in the examples.

### EXAMPLE 1

A printing medium was prepared by combining three 1.0 ounce per square yard spunbond nonwoven fabrics produced by BBA Nonwovens under the designation Reemay Elite, each of which consists of polyethylene terephthalate homopolymer continuous filaments extruded with polyethylene isophthalate copolymer binder filaments and thereafter thermally bonded throughout. The three layers were thermally laminated to one another by passing through a heated calender. The polyethylene isophthalate copolymer present in the layers was activated by the heated calender and served to bond the layers together into a unitary coherent fabric. The resulting composite was so uniform that it was envisioned as a possible print medium for inkjet printers. Experimentation was done with a high resolution HP Inkjet printer that was used in connection with a personal computer. When the calendered thermal lamination was fed through the printer with a high resolution setting the results were very surprising. The clarity of the print was comparable to HP premium Plus Ink Jet Photo Paper but the calendered nature of the nonwoven web gave a very pleasing canvas-like or textured fabric-like appearance to the printed page. The additional benefit was that the resulting printed image on the calendered spunbond printing medium was a very flexible sheet as compared to the HP photo paper which was very stiff.

### EXAMPLE 2

While printing on the calendered polyester spunbond fabric of Example 1 is quite acceptable and shows good color and detail, the receptivity and long term stability of the polyester to conventional inkjet coating can be enhanced by applying an inkjet receptive coating to the medium. These coating compositions typically are pigment dispersions in a polymeric binder comprising polyvinyl alcohol, vinyl acetate copolymers, or other polymers and copolymers. To verify that inkjet receptive coatings were compatible and useable, various coating levels were applied to sheets of calendered nonwoven fabric of Example 1. Two coatings were evaluated: Berjet® 2006 and 2007 made by Bercen Inc., 1381 Cranston Street, Cranston, R.I. The coating compounds were applied at levels between 7.5 lb/ream (3300 sq. ft.) and 17.5 lb/ream (˜25 gsm/square meter). Another coating composition from Sun Process Converting Inc., 1660 Kenneth Drive, Mt. Prospect, Ill. was also evaluated. When the coated printing medium was run through a HP CP 1160 and an HP 7150 printer set at best print quality, the image quality, color definition and color brightness was comparable or better than HP's best Premium Plus Photo Paper. No bleed through or color migration was noted.

The printing medium has broad application as printing media for a variety of print applications including narrow format inkjet printing, wide format commercial ink-jet printing; consumer inkjet printing (typically linked to PC's), screen printing; flexographic printing, lithography, offset printing, letterpress printing and gravure printing. Because of its excellent resistance to high temperatures, it can be used as a printing medium in black and white and in color laser printers which utilize elevated temperature fuser rolls. The printing medium is excellent for photographic prints and other applications where high resolution is needed. The printing medium is suitable for the kind of printing done by sterile packaging manufacturers where high resolution of print is required in a flexible high strength packaging material. Tests that have compared non-coated calendered product of the present invention to non-coated Tyvek show a major improvement over the Tyvek. Typical ink jet printing of Tyvek shows a shadow around images when the ink has migrated, whereas this does not occur with the printing medium of the present invention.

That which is claimed:

1. A nonwoven fabric printing medium comprising a first nonwoven fabric layer formed of thermoplastic polymer continuous filaments, said first nonwoven fabric layer having an outer surface adapted to receive printing ink, and at least one additional nonwoven fabric layer bonded to said first nonwoven fabric layer to form an integral unitary composite sheet material, the nonwoven fabric printing medium having a porosity of no more than 75 CFM pursuant to ASTM D-737-80.

2. The printing medium of claim 1, in which the porosity of the printing medium is no more than 25 CFM pursuant to ASTM D-737-80.

3. The printing medium of claim 1, wherein said first nonwoven fabric layer also includes a thermoplastic polymer binder bonding together the thermoplastic polymer continuous filaments of said first layer, and wherein the same thermoplastic binder also bonds said first nonwoven fabric layer to said at least one additional nonwoven fabric layer.

4. The printing medium of claim 3, wherein said thermoplastic polymer binder is initially in fibrous form.

5. The printing medium of claim 3, wherein the continuous filaments of said first layer have a trilobal cross-section.

6. The printing medium of claim 3, wherein said continuous thermoplastic polymer filaments are formed from polyester.

7. The printing medium of claim 6, wherein said thermoplastic polymer binder comprises a polyester copolymer having a lower melting temperature than the polyester polymer of said continuous filaments.

8. The printing medium of claim 1, in which said outer surface is a smooth calendered surface having a surface roughness R_{z} of no more than 10 μm.

9. The printing medium of claim 1, wherein said first nonwoven fabric layer comprises a spunbond nonwoven formed from continuous polyester homopolymer matrix filaments of a trilobal cross-section, and a fibrous binder of a lower-melting polyester copolymer which bond the continuous matrix filaments.

10. The printing medium of claim 9, wherein said at least one additional nonwoven fabric layer comprises a second spunbond nonwoven fabric bonded to said first fabric, said second spunbond fabric being formed from continuous polyester homopolymer matrix filaments of a trilobal cross-section, and a fibrous binder of a lower-melting polyester copolymer which bond the continuous matrix filaments.

11. The printing medium of claim 1, wherein the filaments of said spunbond layer are from about 1 to 10 denier per filament.

12. The printing medium of claim 1, in which the overall basis weight is at least 3 ounces per square yard.

13. The printing medium of claim 1, including a coating of an ink-receptive composition on said outer surface.

14. The printing medium of claim 1 having a grab tensile strength in both the CD and XD of at least 120 pounds.

15. A nonwoven fabric printing medium comprising: a first nonwoven fabric layer having a calendered outer surface adapted to receive printing ink, and comprising a spunbond nonwoven formed from continuous polyester homopolymer matrix filaments of a trilobal cross-section and a fibrous binder of a lower-melting polyester copolymer which bonds the continuous matrix filaments, and a second nonwoven fabric layer bonded to said first nonwoven fabric layer and comprising a spunbond nonwoven formed from continuous polyester homopolymer matrix filaments of a trilobal cross-section and a fibrous binder of a lower-melting polyester copolymer which bonds the continuous matrix filaments of the second nonwoven fabric layer, and wherein the copolymer binder present in said first and second layers also bonds the first and second layers to one another, and said printing medium having a porosity of no more than 25 CFM pursuant to ASTM D-737-80.

16. The printing medium of claim 15, in which the nonwoven fabric layers thereof are formed entirely of polyester.

17. The printing medium of claim 15, including a coating of an ink-receptive composition on said calendered outer surface.

18. The printing medium of claim 15, wherein the first and second nonwoven fabric layers are bonded directly to one another by said binder filaments of lower melting polyester copolymer.

19. The printing medium of claim 15, additionally including at least one intermediate nonwoven fabric layer disposed between said first and second nonwoven fabric layers and bonded thereto.

20. A nonwoven fabric printing medium comprising: a first nonwoven fabric layer having an outer surface with a surface roughness R_{z} of no more than 10 μm, said first nonwoven fabric layer formed from continuous polyethylene terephthalate homopolymer matrix filaments of about 1 to 10 denier per filament and a fibrous binder of a lower-melting polyethylene isophthalate copolymer which bonds the continuous matrix filaments, a second nonwoven fabric layer bonded to said first nonwoven fabric layer and formed from continuous polyethylene terephthalate homopolymer matrix filaments and a fibrous binder of a lower-melting polyethylene isophthalate copolymer which bonds the continuous matrix filaments of the second nonwoven fabric layer, and wherein the polyethylene isophthalate copolymer binder present in said first and second layers also bonds the first and second layers to one another, and the printing medium having a basis weight of 3 to 12 ounces per square yard and a porosity of no more than 25 CFM pursuant to ASTM D-737-80.

21. A method of producing a printing medium, comprising
forming a nonwoven fabric first layer of continuous thermoplastic polymer filaments;
forming a nonwoven fabric second layer;
directing said first and second nonwoven fabric layers into overlying relation with one another;
bonding said first and second layers in opposing face-to-face relationship to form a composite nonwoven fabric; and
calendering the exposed outer surface of said first nonwoven fabric layer to form a calendered outer surface adapted to receive printing ink. with the printing medium having a porosity of no more than 75 CFM pursuant to ASTM D-737-80.

22. A method according to claim 21, wherein said bonding step comprises transporting the printing medium through a nip between a pair of cooperating calender rolls.

23. A method according to claim 22, wherein said bonding further comprises transporting the printing medium through a second nip between a second pair of cooperating calender rolls, said second nip exerting a higher pressure than the first nip.

24. A method according to claim 23, wherein the gap within the second nip is narrower than the gap within the first nip.

25. A method according to claim 21 including the step of applying an ink-receptive coating to the outer surface of said first nonwoven fabric layer.

26. A method according to claim 21, wherein said step of forming a nonwoven fabric first layer and said step of forming a nonwoven fabric second layer comprise forming respective spunbond nonwoven fabric layers from continuous polyester homopolymer matrix filaments of a trilobal cross-section and a fibrous binder of a lower-melting polyester copolymer which bonds the continuous matrix filaments, and wherein said step of bonding said first and second layers in opposing face-to-face relationship includes heating the respective fabric layers so that the copolymer binder present in the first and second layers softens to fuse and bond the layers to one another.
